(19) United States
(12) Patent Application Publication
(10) Pub. No.: US 2026/0266452 A1
(43) Pub. Date: Sep. 10, 2026

(54) PORTABLE LIGHT

(71) Applicant: MILWAUKEE ELECTRIC TOOL CORPORATION, Brookfield, WI (US)

(72) Inventors: Benjamin J. Roubik, Milwaukee, WI (US); Chelsea L. Rubietta, Oak Creek, WI (US); Duane W. Wenzel, Mukwonago, WI (US); Matthew D. Strommen, Greendale, WI (US); Nathan S. Meyer, Jackson, WI (US)

(21) Appl. No.: 19/556,023

(22) Filed: Mar. 4, 2026

Related U.S. Application Data
(60) Provisional application No. 63/767,235, filed on Mar. 5, 2025.
(60) Provisional application No. 63/824,956, filed on Jun. 17, 2025.

(51) Int. Cl. F21V 21/14; F21L 4/04; F21V 21/088; F21V 21/096; F21V 21/30; F21V 23/00; F21V 23/02; F21V 23/04; F21V 31/00; F21Y 115/10

(52) U.S. Cl. CPC F21V 21/145; F21L 4/045; F21V 21/0885; F21V 21/0965; F21V 21/30; F21V 23/006; F21V 23/009; F21V 23/023; F21V 23/0428; F21V 31/005; F21Y 2115/10

(57) ABSTRACT

A portable light including a base having a first end, a second end opposite the first end, a longitudinal member extending between the first end and the second end, and a kickstand extending radially outward from the first end. The portable light includes a main body defining a central longitudinal axis. The main body is rotatably coupled to the base at the first end and the second end such that the main body is rotatable relative to the base about the central longitudinal axis. The portable light includes a light head rotatably coupled to the main body, the light head including a light source configured to be selectively powered by a power source.

### CROSS-REFERENCE TO RELATED APPLICATIONS

The application claims priority to U.S. Provisional Patent Application No. 63/824,956, filed Jun. 17, 2025, and U.S. Provisional Patent Application No. 63/767,235, filed Mar. 5, 2025, the entire contents of all of which are incorporated by reference herein.

### FIELD OF THE DISCLOSURE

The present disclosure relates to a portable light.

### BACKGROUND OF THE DISCLOSURE

Portable lights are used to illuminate a surrounding environment.

### SUMMARY OF THE DISCLOSURE

The present disclosure provides, in one aspect, a portable light including a base having a first end, a second end opposite the first end, a longitudinal member extending between the first end and the second end, and a kickstand extending radially outward from the first end. The portable light includes a main body defining a central longitudinal axis. The main body is rotatably coupled to the base at the first end and the second end such that the main body is rotatable relative to the base about the central longitudinal axis. The portable light includes a light head rotatably coupled to the main body, the light head including a light source configured to be selectively powered by a power source.

The present disclosure provides, in another aspect, a portable light including a base having a first end, a second end opposite the first end, a longitudinal member extending between the first end and the second end, and a carabiner clip extending radially outward from the first end. The portable light includes a main body defining a central longitudinal axis, the main body is rotatably coupled to the base at the first end and the second end such that the main body is rotatable relative to the base about the central longitudinal axis, the main body configured to support a power source. The portable light includes a light head rotatably coupled to the main body by a hinge such that the light head is rotatable relative to the main body about a light axis that is perpendicular to the central longitudinal axis, the light head including a light source configured to be selectively powered by a power source.

The present disclosure provides, in yet another aspect, a portable light including a base having a first end, a second end opposite the first end, and a longitudinal member extending between the first and second ends, the first and second ends each having a hoop shape. The portable light includes a main body defining a central longitudinal axis, the main body rotatably coupled to the base at the first and second ends such that the main body is rotatable relative to the base about the central longitudinal axis, the main body including a battery receptacle configured to support a power source. The portable light further includes a light head rotatably coupled to the main body, the light head including a light source configured to be selectively powered by a power source.

### BRIEF DESCRIPTION OF THE DRAWINGS

FIG. 1 is a front perspective view of a portable light, according to a construction of the present disclosure.

FIG. 2 is a rear perspective view of the portable light of FIG. 1.

FIG. 3 is a perspective view of a base of the portable light of FIG. 1.

FIG. 4 is another perspective view of the base of FIG. 3.

FIG. 5 is a perspective view of the base of FIG. 3 with a hook rotated relative to a kickstand.

FIG. 6 is a cross-sectional view of the base of FIG. 4 taken along line 6-6.

FIG. 7 is a cross-sectional view of the base of FIG. 4 taken along line 7-7.

FIG. 8 is a schematic view of a magnet arrangement of the portable light of FIG. 1.

FIG. 9 is a schematic view of another magnet arrangement of the portable light of FIG. 1.

FIG. 10 is a graph illustrating a pull force of the magnet arrangements of FIGS. 8 and 9 relative to an air gap.

FIG. 11A is a front view of the portable light of FIG. 1.

FIG. 11B is a front schematic view of the portable light of FIG. 1.

FIG. 12A is a rear view of the portable light of FIG. 1.

FIG. 12B is a rear schematic view of the portable light of FIG. 1.

FIG. 13 is a cross-sectional view of the portable light of FIG. 12A taken along line 13-13.

FIG. 14A is a bottom view of the portable light of FIG. 1.

FIG. 14B is a bottom schematic view of the portable light of FIG. 1.

FIG. 15A is a side view of the portable light of FIG. 1.

FIG. 15B is a side schematic view of the portable light of FIG. 1.

FIG. 16A is another side view of the portable light of FIG. 1.

FIG. 16B is another side schematic view of the portable light of FIG. 1.

FIG. 17 is a perspective view of the portable light in an open position.

FIG. 18 is a perspective view of the portable light in a closed position.

FIG. 19 is a perspective view of the portable light in the open position.

FIG. 20 is a perspective view of a light head and a main body of the portable light rotated relative to the base.

FIG. 21 is a perspective view of the light head rotated relative to the main body of the portable light.

FIG. 22 illustrates the portable light of FIG. 1 stowed in a pocket.

FIG. 23 illustrates the portable light of FIG. 1 stowed in a cup holder.

FIG. 24 illustrates the portable light of FIG. 1 hanging on a nail.

FIG. 25 illustrates the portable light of FIG. 1 coupled to a ferromagnetic surface.

FIG. 26 illustrates the portable light of FIG. 1 coupled to a backpack.

FIG. 27 illustrates the portable light of FIG. 1 coupled to a belt loop.

FIG. 28 is a front perspective view of a portable light, according to another construction of the present disclosure.

FIG. 29 is a rear perspective view of the portable light of FIG. 28.

FIG. 30 is another front perspective view of the portable light of FIG. 28 with a light head rotated.

FIG. 31 is a bottom perspective view of a second end and a longitudinal member of a base of the portable light of FIG. 28.

FIG. 32 is a perspective view of steel plates and a magnet of the base of the portable light of FIG. 28.

FIG. 33 is a front perspective view of the second end and the longitudinal member of the base receiving the magnets of FIG. 32.

FIG. 34 is a front perspective view of a main body of the portable light of FIG. 28 receiving a printed circuit board.

FIG. 35 is another front perspective view of the base of the portable light of FIG. 28 receiving fasteners.

FIG. 36 is a front perspective view of the base of the portable light of FIG. 28 receiving the second end, the longitudinal member, and an attachment.

FIG. 37 is a rear perspective view of a carabiner clip of the portable light of FIG. 28.

FIG. 38 is a front perspective view of the base of the portable light of FIG. 28.

FIG. 39 is a perspective view of a housing and a hinge of the portable light of FIG. 28.

FIG. 40 is a cross-sectional view of a plate compatible with the hinge of FIG. 39.

FIG. 41 is an exploded perspective view of a lens assembly of the portable light of FIG. 28.

FIG. 42 is a front perspective view of coupling a PCB to the housing of the light head of the portable light of FIG. 28.

FIG. 43 is a rear perspective view of coupling the lens assembly to the housing of the portable light of FIG. 28.

FIG. 44 is a top perspective view of coupling the light head to the main body.

FIG. 45 is a cross-sectional view of the portable light of FIG. 28 taken along line 45-45.

FIG. 46 is a front perspective view of a power contact of an end cap of the portable light of FIG. 28.

FIG. 47 is a front perspective view of another power contact compatible with the end cap of the portable light of FIG. 28.

FIG. 48 is a front view of the portable light of FIG. 28.

FIG. 49 is a top view of the portable light of FIG. 28.

FIG. 50 is a rear view of the portable light of FIG. 28.

FIG. 51 is a bottom view of the portable light of FIG. 28.

FIG. 52 is a side view of the portable light of FIG. 28.

FIG. 53 is another side view of the portable light of FIG. 28.

Before any constructions of the disclosure are explained in detail, it is to be understood that the disclosure is not limited in its application to the details of construction and the arrangement of components set forth in the following description or illustrated in the following drawings. The disclosure is capable of other constructions and of being practiced or of being carried out in various ways.

### DETAILED DESCRIPTION

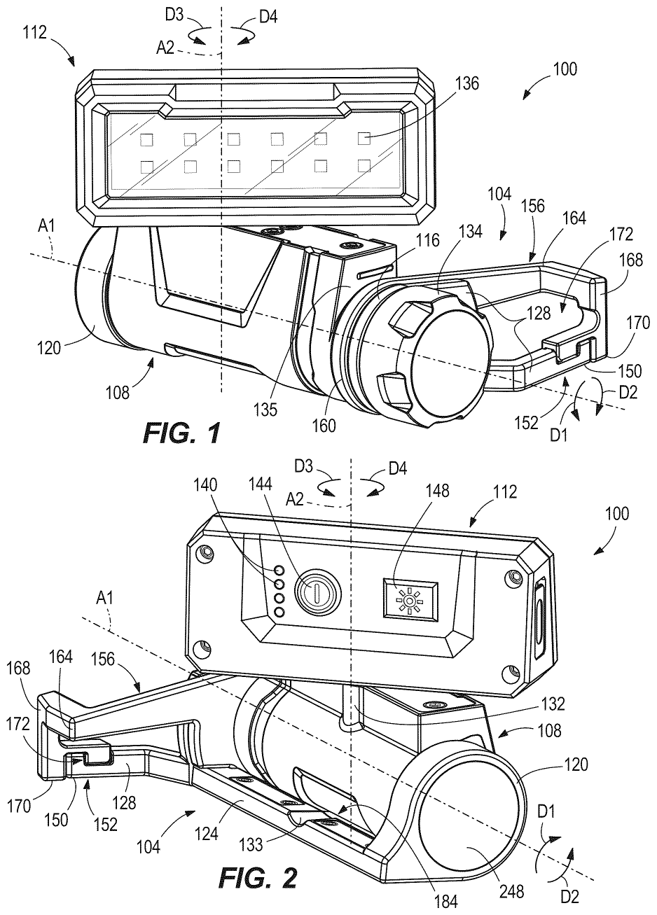

FIGS. 1-2 illustrate a portable light 100 having a base 104, a main body 108 rotatably coupled to the base 104, and a light head 112 rotatably coupled to the main body 108. The base 104 includes a first end 116, a second end 120 opposite the first end 116, a longitudinal member 124 extending between the first end 116 and the second end 120, and a kickstand 128 extending radially outward from the first end 116.

Although the illustrated device is a portable light including a light head, in other embodiments, the device may include other types of output heads. For example, the device may be a portable speaker including a speaker head or a portable fan including a fan head. The speaker head or the fan head may be coupled to and movable relative to the main body 108 and/or the base 104 in a similar manner as the light head 112, and have similar profiles as the light head 112, but with different output elements (e.g., speakers, fan, etc.) rather than the lights of the light head 112, and other components specific to the light head 112. In some embodiments, the device may be a combination device and include a combination head, such as a combination fan and light head, a combination speaker and light head, or a combination fan, speaker, and light head.

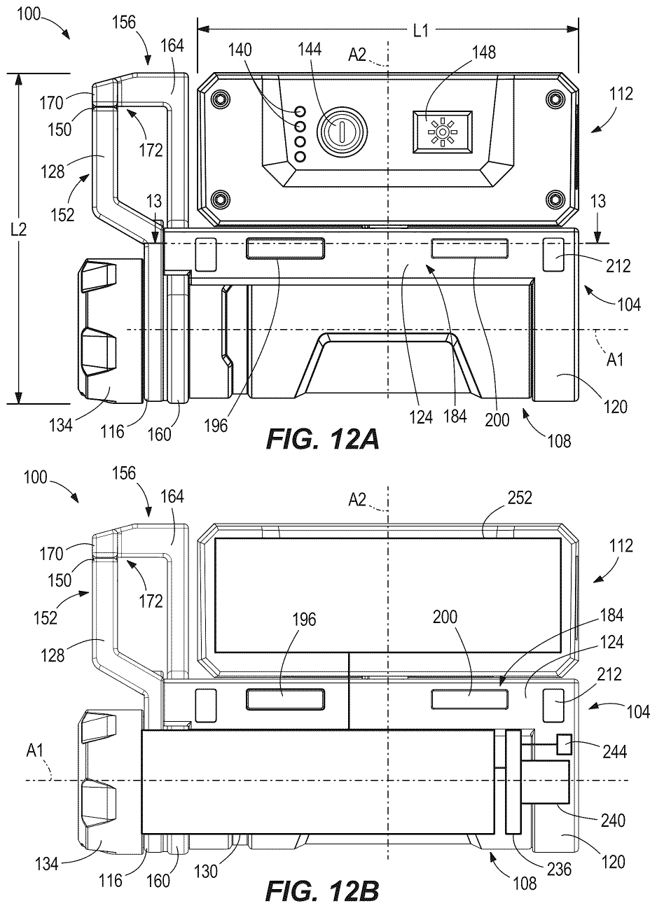

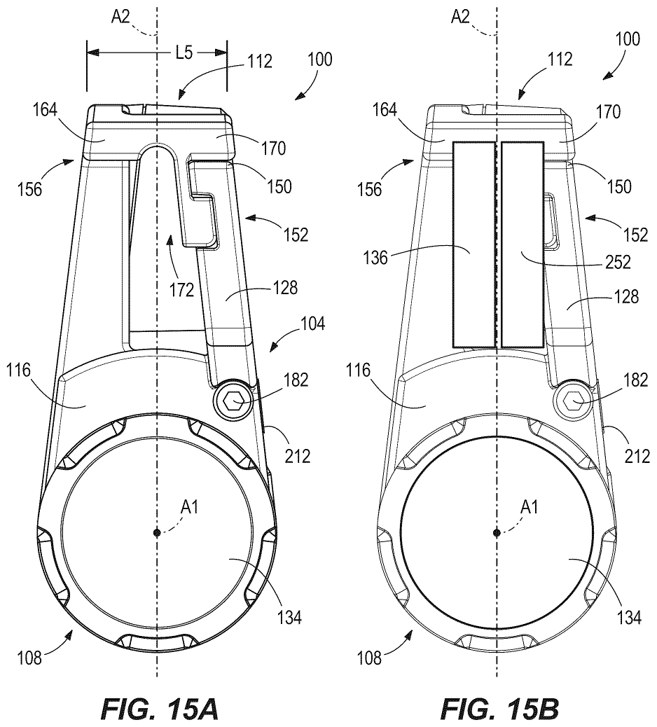

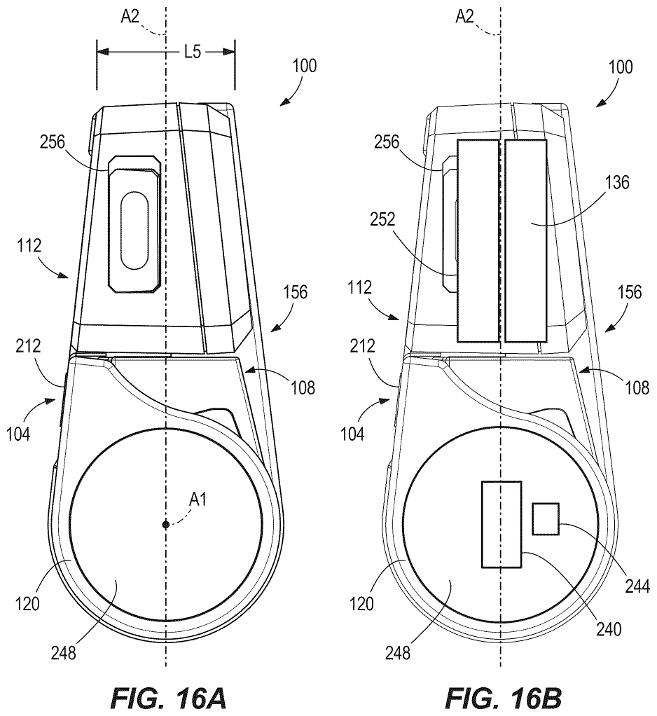

The main body 108 is received by the first end 116 and the second end 120 and extends between the first end 116 and the second end 120. The main body 108 is configured to receive a power source 130 (FIG. 12B). In the illustrated construction, the main body 108 defines a battery receptacle 131 configured to receive the power source 130. The main body 108 defines a central longitudinal axis A1 and is rotatably coupled to the base 104 at the first end 116 and the second end 120 such that the main body 108 rotates about the longitudinal axis A1. In the illustrated construction, the longitudinal axis A1 extends through a center of the battery receptacle 131. In the illustrated construction, the first end 116 and the second end 120 are concentric with the longitudinal axis A1. In other words, the first end 116 and the second end 120 are concentric with the battery receptacle 131. The main body 108 includes a projection 132, and the base 104 includes a recess 133 configured to receive the projection 132 when the main body 108 is in a collapsed position (FIGS. 15A-16B). In the collapsed position, the main body 108 is aligned with the kickstand 128 (FIGS. 15A-16B). The portable light 100 includes an end cap 134 that secures the base 104 to the main body 108. The main body 108 includes a wall 135 that contacts the base 104 such that the base 104 is between the end cap 134 and the wall 135.

The light head 112 is rotatably mounted to the main body 108 and is configured to pivot about a light axis A2. In the illustrated construction, the light axis A2 bisects the light head 112 in a direction perpendicular to the longitudinal axis A1. The light head 112 includes a light source 136 that is selectively powered by the power source 130. In the illustrated construction, the light source 136 includes light emitting diodes (LEDs). The light source 136 is configured to provide flood lighting to a surrounding environment. The light head 112 includes an indicator 140, a switch 144, and a switch 148. The indicator 140, the switch 144, and the switch 148 are located on a backside of the light head 112, opposite from the light source 136. In the illustrated construction, the indicator 140 provides information regarding the supply of the power source 130, the switch 144 is a power switch configured to toggle the light source 136 between on and off, and the switch 148 toggles different modes of the light source 136 (e.g., low, medium, and high). Together, the indicator 140, the switch 144, and the switch 148 form a user interface.

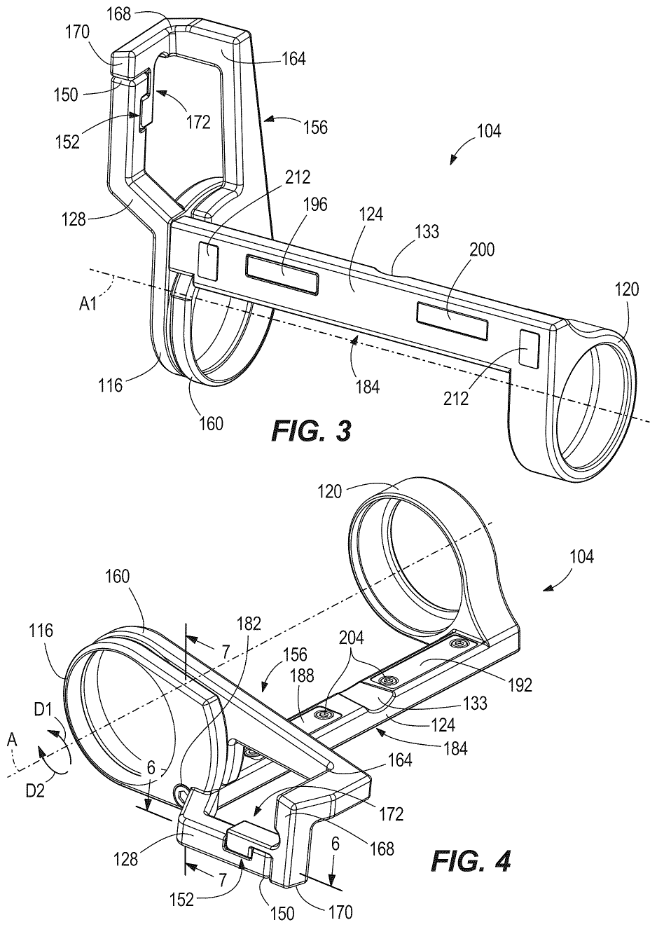

FIGS. 3-7 illustrate the base 104 having the first end 116 and the second end 120. In the illustrated construction, the first end 116 is a circular band that is configured to surround a portion of the main body 108. The first end 116 is sandwiched between the main body 108 and the end cap 134 such that the first end 116 does not slide off the main body 108. In the illustrated construction, the second end 120 is a circular band that is configured to a surround a portion of the main body 108. The kickstand 128 extends from the circular band of the first end 116. In other constructions, the kickstand 128 may extend from the circular band of the second end 120. In the illustrated construction, the kickstand 128 and the circular band are integrated or monolithic. In other constructions, the kickstand 128 may be a separate component that is coupled to the circular band. The kickstand 128 includes an end 150 having a receptacle 152.

The base 104 includes a hook 156 that is rotatably coupled to the main body 108. The hook 156 is also rotatable relative to the first end 116, the second end 120, and the longitudinal member 124 of the base 104. In the illustrated construction, the hook 156 includes a circular band 160. Similar to the first end 116, the circular band 160 is configured to surround a portion of the main body 108. In the illustrated construction, the circular band 160 is disposed nearer to the first end 116 than to the second end 120. Specifically, the circular band 160 is disposed between the first end 116 and the wall 135 of the main body 108 (FIG. 1). The circular band 160 is sandwiched between the first end 116 and the wall 135 such that the circular band 160 does not slide off the main body 108. The hook 156 extends radially outward from the circular band 160. The hook 156 includes a first bend 164 and a second bend 168. The first bend 164 is bent or angled relative to the circular band 160. The second bend 168 is bent or angled relative to the first bend 164. In the illustrated construction, the first bend 164 is a 90-degree bend and the second bend 168 is a 90-degree bend. The hook 156 includes an end 170 having a receptacle 172 that corresponds with the receptacle 152. The receptacle 172 extends radially inward toward the longitudinal axis A1. In some constructions, the hook 156 can be replaced by another hook in the instance that a different hook design is desired. To remove the hook 156, the end cap 134 is removed from the main body 108 and the base 104 is removed from the main body 108 such that the hook 156 can be replaced.

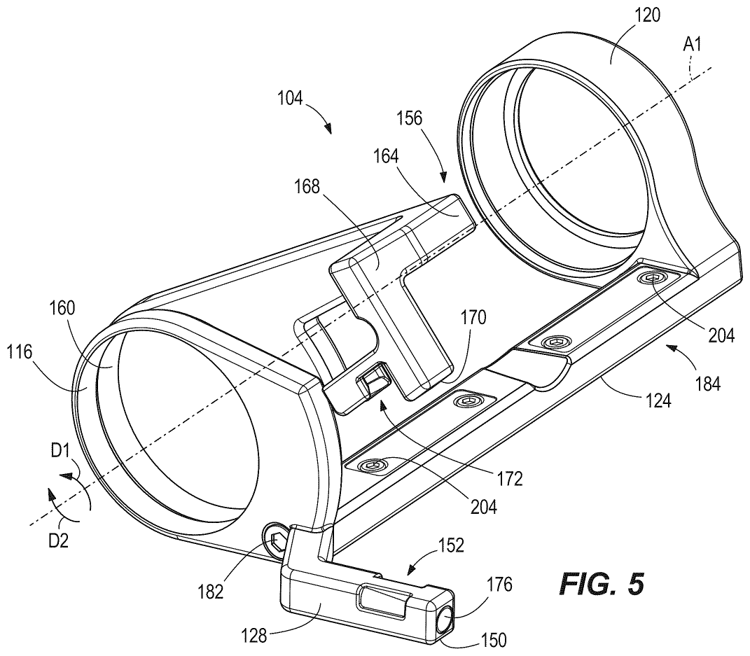

FIG. 5 illustrates that the hook 156 can be rotated relative to the first end 116 and the second end 120. Specifically, the hook 156 can be rotated about the longitudinal axis A1 in a first direction D1 and a second direction D2, the second direction D2 being opposite from the first direction D1. The receptacle 152 includes a magnet 176. In the illustrated construction, the magnet 176 is overmolded within an end of the receptacle 152.

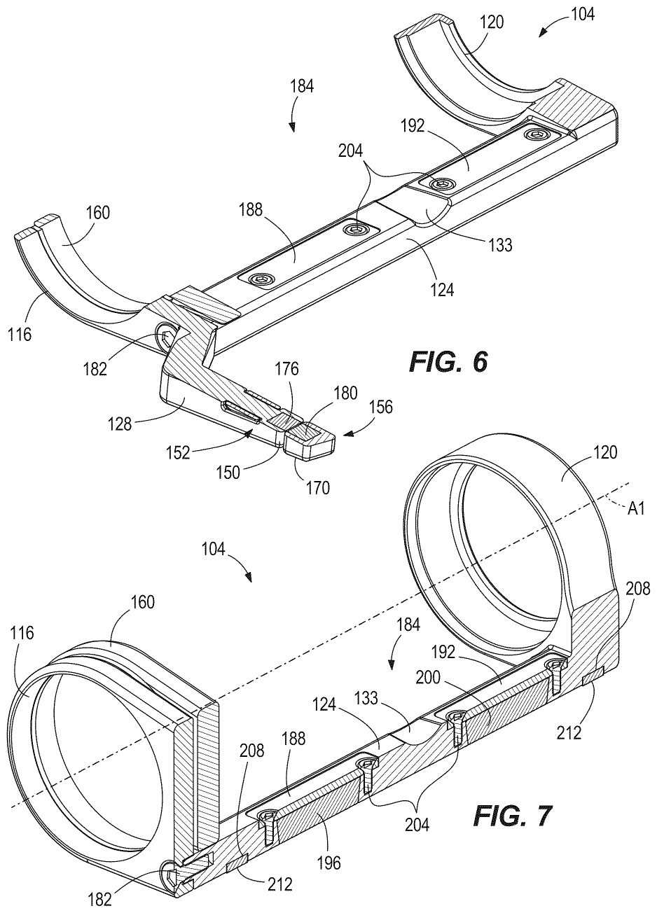

FIG. 6 illustrates the receptacle 172 of the hook 156 engaging the receptacle 152 of the kickstand 128. The receptacle 172 includes a magnet 180 that engages the magnet 176 of the receptacle 152 such that the hook 156 and the kickstand 128 are held relative to one another in a closed position (e.g., relative motion between the hook 156 and the kickstand 128 is inhibited). In the closed position, the receptacle 172 of the hook 156 interfaces with the receptacle 152 of the kickstand 128 (FIG. 4). In the closed position, the kickstand 128 and the hook 156 cooperate to form a closed loop.

FIG. 7 illustrates that the first end 116 is coupled to the longitudinal member 124 by a fastener 182. The second end 120 and the longitudinal member 124 are a single piece (e.g., monolithic). In the illustrated construction, the first end 116 is fixed relative to the longitudinal member 124 such that the kickstand 128 does not move relative to the longitudinal member 124. In other constructions, the first end 116 and the longitudinal member 124 are a single piece (e.g., monolithic). In other constructions, the second end 120 is formed separately from the longitudinal member 124 and is coupled to the longitudinal member 124 via a fastener.

FIG. 7 illustrates the base 104 including a magnet arrangement 184. Specifically, the magnet arrangement 184 is disposed in the longitudinal member 124. The magnet arrangement 184 includes a first metal plate 188 (e.g., a steel plate), a second metal plate 192 (e.g., a steel plate), a first magnet 196, and a second magnet 200. The first metal plate 188 abuts the first magnet 196. The second metal plate 192 abuts the second magnet 200. In other constructions, the magnet arrangement 184 includes a single metal plate that abuts both the first magnet 196 and the second magnet 200. In the illustrated construction, the first magnet 196 is overmolded into the longitudinal member 124 and the second magnet 200 is overmolded into the longitudinal member 124. In the illustrated construction, the first magnet 196 is closer to the first end 116 than the second end 120 and the second magnet 200 is closer to the second end 120 than the first end 116. The second magnet 200 is spaced apart from the first magnet 196 in a direction parallel to the longitudinal axis A1. The first steel plate 188 and the second steel plate 192 are coupled to the longitudinal member 124 via fasteners 204. The magnet arrangement 184 is disposed between the first end 116 and the second end 120 of the longitudinal member 124. The base 104 includes recesses 208 and pads 212 received in the recesses 208. In some constructions, the pads 212 are comprised of an elastomer (e.g., rubber, neoprene, etc.). A pad of the pads 212 is disposed between the first end 116 and the first magnet 196. Another pad of the pads 212 is received between the second end 120 and the second magnet 200. The pads 212 are configured to create an airgap G1 between the magnets 196, 200 and a workpiece 216. As such, the magnets 196, 200 do not directly contact the workpiece 216. The magnet arrangement 184 is configured to permit the portable light 100 to be coupled to a ferromagnetic material (e.g., iron, nickel, cobalt).

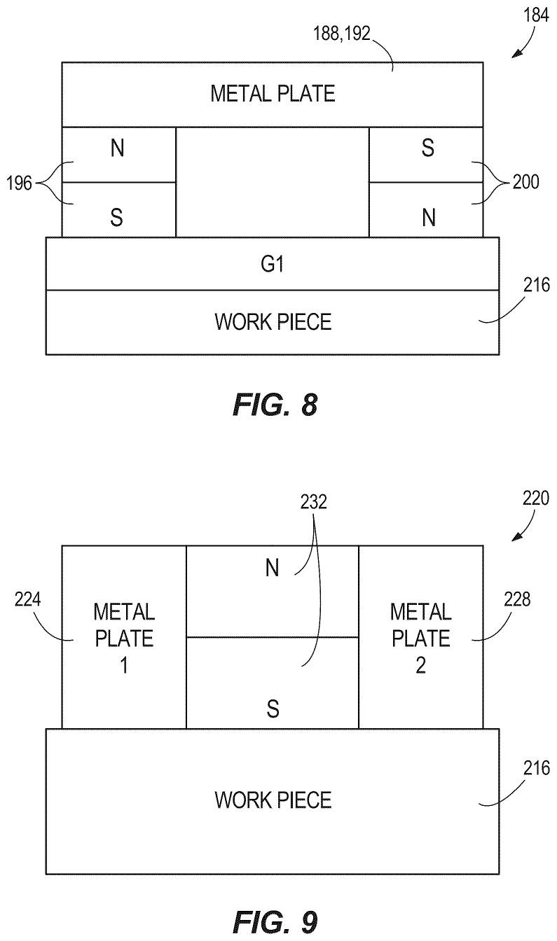

FIG. 8 illustrates the magnet arrangement 184 as a bridge design. The bridge design utilizes two magnets (e.g., the magnets 196, 200) and a metal plate (e.g., the steel plates 188, 192) extending therebetween. As shown in FIG. 7, the steel plates 188, 192 are separated. However, the steel plates 188, 192 contribute the same effect as a single steel plate. The pads 212 disposed proximal to the magnets 196, 200 define the airgap G1 between the magnets 196, 200 and the workpiece 216.

FIG. 9 illustrates a magnet arrangement 220 that is interchangeable with the magnet arrangement 184. In other words, the magnet arrangement 220 can be used in the longitudinal member 124 rather than the magnet arrangement 184. The magnet arrangement 220 is a sandwich design. The magnet arrangement 220 includes a first metal plate 224, a second metal plate 228, and a magnet 232 flanked by the metal plates 224, 228.

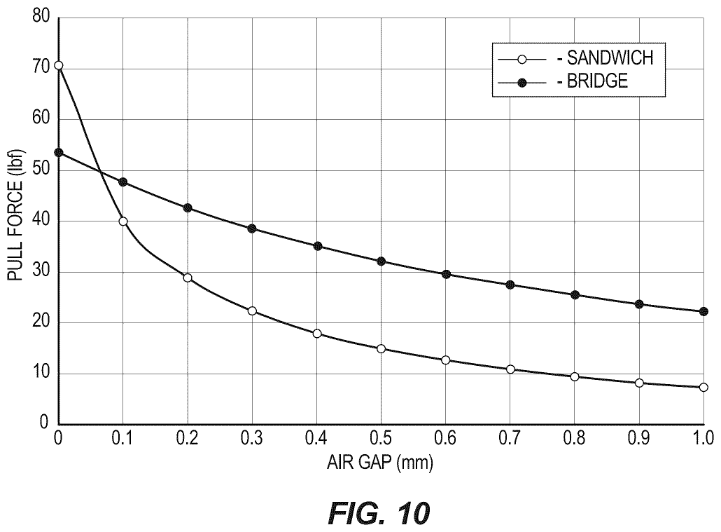

FIG. 10 illustrates the magnet arrangement 184 (e.g., bridge design) and the magnet arrangement 220 (e.g., sandwich design). In instances of no airgap between a workpiece, the magnet arrangement 220 provides the most pull force at approximately 70 lbf. The magnet arrangement 184 provides approximately 55 lbf with no airgap. However, the pull force when using the magnet arrangement 184 decreases at a smaller rate compared to the magnet arrangement 220 as the airgap is increased.

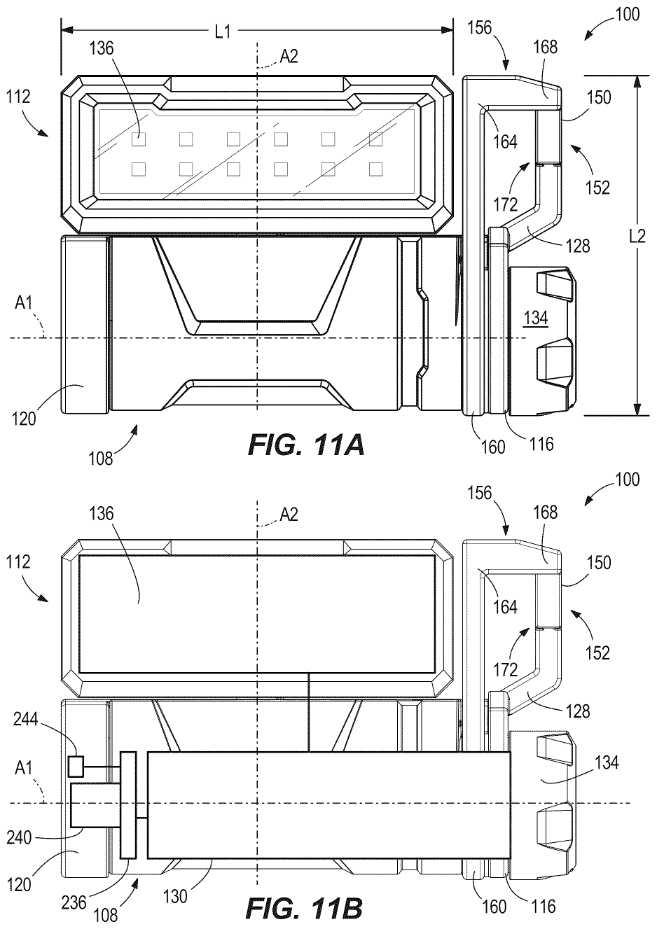

FIGS. 11A-12B illustrate the light head 112 of the portable light 100 defining a first length L1. The first length L1 is measured in a direction parallel to the longitudinal axis A1. The first length L1 may be between approximately 50 millimeters and approximately 100 millimeters. In the illustrated construction, the first length L1 is 78.6 millimeters. In some constructions, the first length L1 is less than 78.6 millimeters. In some constructions, the first length L1 is more than 78.6 millimeters. The kickstand 128 defines a second length L2. The second length L2 is measured in a direction parallel to the light axis A2. In the illustrated construction, a length of the main body 108 and the light head 112 in the same direction as the light axis A2 is the same length as the second length L2. The second length L2 may be between approximately 50 millimeters and 100 millimeters. In the illustrated construction, the second length L2 is approximately 72.5 millimeters. In other constructions, the second length L2 is less than 72.5 millimeters. In other constructions, the second length L2 is greater than 72.5 millimeters.

FIG. 11B illustrates the portable light 100 with the power source 130 (e.g., a battery) supported in the main body 108. To remove the hook 156 and/or battery 130, the end cap 134 is removed from the main body 108 such that the battery 130 can be removed from the main body 108. In other words, the end cap 134 is configured to selectively enclose the battery 130 in the main body 108. In the illustrated construction, the power source 130 is a battery that may be a 4-volt rechargeable power tool battery pack. The battery 130 may include one or more battery cells having, for example, a lithium (Li), lithium-ion (Li-ion), or other lithium-based chemistry. For example, the battery cells may have a chemistry of lithium-cobalt (Li—Co), lithium-manganese (Li—Mn) spinel, or Li—Mn nickel. In other constructions, the battery cells may have a nickel-cadmium, nickel-metal hydride, or lead acid battery chemistry. In yet another construction, the battery 130 may be a dedicated battery housed (partially or entirely) within the main body 108. The battery 130 is configured to supply power to the light source 136. In the illustrated construction, the battery 130 is a single cell battery. In the illustrated construction, the battery 130 has a positive terminal and a negative terminal disposed on the same end of the longitudinal end of the battery 130. That is, the positive and the negative terminal share an end of the battery 130. The battery 130 is received by the battery receptacle 131. In the illustrated construction, the battery 130 is cylindrical and is therefore received longitudinally along the longitudinal axis A1. The battery 130 defines an axis that is aligned with the longitudinal axis A1 when the battery 130 is received in the battery receptacle 131. In other words, the battery 130 is concentrically arranged in the battery receptacle 131. As shown in FIG. 11B, the electrical connection between the battery 130 and the light source 136 extends through a rotational joint (e.g., the projection 132) that couples the main body 108 to the light head 112.

FIG. 11B illustrates that the portable light 100 includes a printed circuit board 236 (PCB), a first port 240, a second port 244, and the light source 136. The PCB 236 is disposed in the main body 108 and is oriented perpendicular to the longitudinal axis A1. The PCB 236 is disposed in the main body 108 nearer to an end 248 of the main body 108 than the wall 135 (FIG. 16A). The end 248 is adjacent to the second end 120 of the base 104. The first port 240 and the second port 244 are disposed at the end 248. In the illustrated construction, the first port 240 is configured to supply power to the PCB 236 and therefore the battery 130 since the PCB 236 is connected to the battery 130. In the illustrated construction, the first port 240 is a USB-C port. The second port 244 is configured to supply power to the PCB 236 and therefore the battery 130. In the illustrated construction, the second port 244 is a USB power port. In the illustrated construction, the first port 240 and the second port 244 are different formats (e.g., USB-C and USB). In other constructions, the first port 240 and the second port 244 are the same format. In some constructions, the first port 240 is configured to receive power from an external source and supply the battery 130 with the power and the second port 244 is configured to discharge power from the second port 244 that is supplied from the battery 130.

FIG. 12B illustrates the portable light 100 including a printed circuit board 252 (PCB). The PCB 252 is configured to receive power from the battery 130 and receives signals from the switches 144, 148. The PCB 252 is configured to control the light source 136 (FIG. 11B).

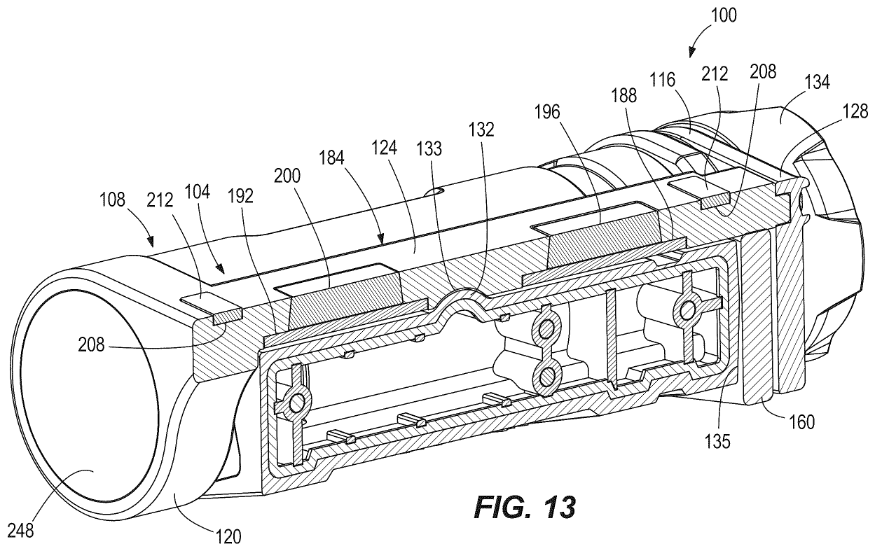

FIG. 13 illustrates the portable light 100 in the collapsed position. In the collapsed position, the projection 132 of the main body 108 is received within the recess 133 of the base 104 such that the main body 108 is flush with the base 104. That is, the main body 108 does not extend vertically beyond (i.e., above or below) the first and second ends 116, 120 of the base 104, as viewed in FIG. 13.

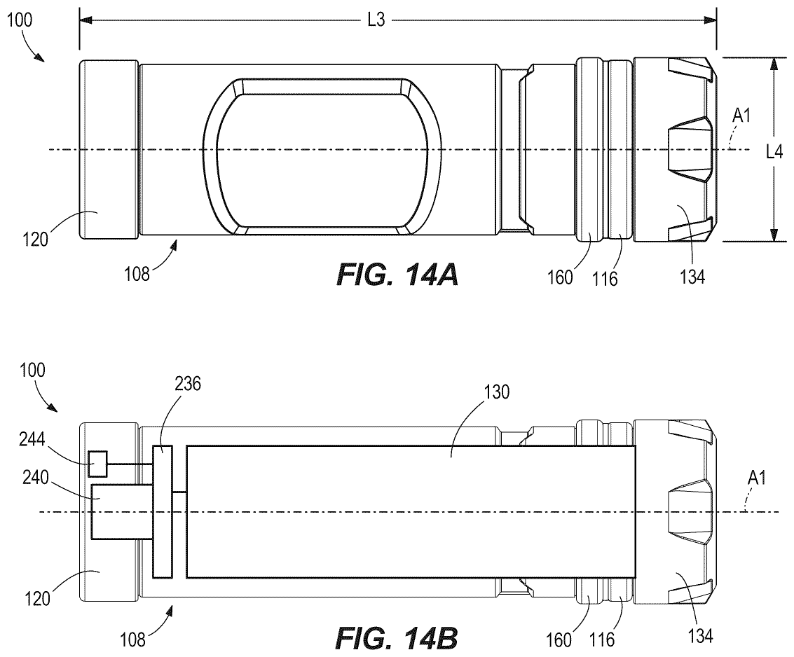

FIGS. 14A-14B illustrate the main body 108 and the end cap 134 defining a third length L3. The third length L3 is measured in a direction parallel to the longitudinal axis A1. The third length L3 is greater than the first length L1. The third length L3 is between approximately 75 millimeters and approximately 125 millimeters. In the illustrated construction, L3 is 115.5 millimeters. In some constructions, the third length L3 is less than 115.5 millimeters. In some constructions, the third length L3 is more than 115.5 millimeters. The end cap 134 defines a fourth length L4 (or diameter). The fourth length L4 is measured in a direction perpendicular to the longitudinal axis A1. The fourth length L4 is between approximately 20 millimeters and approximately 40 millimeters. In the illustrated construction, the fourth length L4 is 33.5 millimeters. In other constructions, the fourth length L4 is less than 33.5 millimeters. In other constructions, the fourth length L4 is greater than 33.5 millimeters.

FIGS. 15A-16B illustrate the hook 156 defining a fifth length L5 (or width). The fifth length L5 is measured at an outermost location of the hook 156 relative to the longitudinal axis A1 (e.g., at a locations of the bends 164, 168) in a direction perpendicular to the longitudinal axis A1 and perpendicular to the light axis A2. The fifth length L5 is between approximately 10 millimeters and approximately 20 millimeters. In the illustrated construction, the fifth length L5 is approximately 14 millimeters. In other constructions, the fifth length L5 is less than 14 millimeters. In other constructions, the fifth length L5 is greater than 14 millimeters.

As illustrated in FIGS. 15A-16B, the PCB 252 is disposed between the switches 144, 148 and the light source 136. In the illustrated construction, the light source 136 and the PCB 252 are parallel to one another. In other constructions, the light source 136 is disposed on the

PCB 252. As shown in FIG. 16A, the portable light 100 may include a location 256 for the ports 240, 244. The location 256 is disposed on the light head 112 nearer to the second end 120 than the first end 116. In other words, the ports 240, 244 may be disposed on the light head 112 rather than the end 248 of the main body 108.

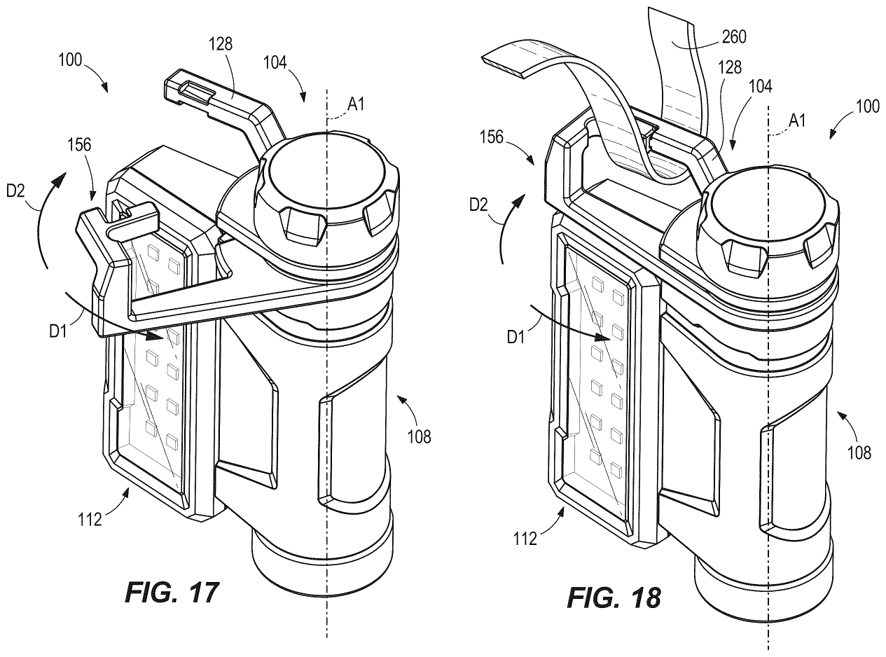

FIGS. 17 and 18 illustrate that the hook 156 is movable about the longitudinal axis A1. The hook 156 is moved from a first position (FIG. 1) in the first direction D1 about the longitudinal axis A1 to a second position (FIG. 17). The first position may also be referred to as a closed position. The second position may also be referred to as an open position. In the open position, the receptacle 172 of the hook 156 is angularly displaced from the receptacle 152 of the kickstand 128 about the axis A1. While in the open position, an external support 260 can be situated between the kickstand 128 and the hook 156. The hook 156 can be moved in the second direction D2 about the longitudinal axis A1 from the open position (FIG. 17) to the closed position with the external support 260 disposed in the closed loop (FIG. 17). The magnets 176 of the receptacle 152 and the magnet 180 of the receptacle 172 maintain the locking position until a user overpowers a force of the magnets 176, 180.

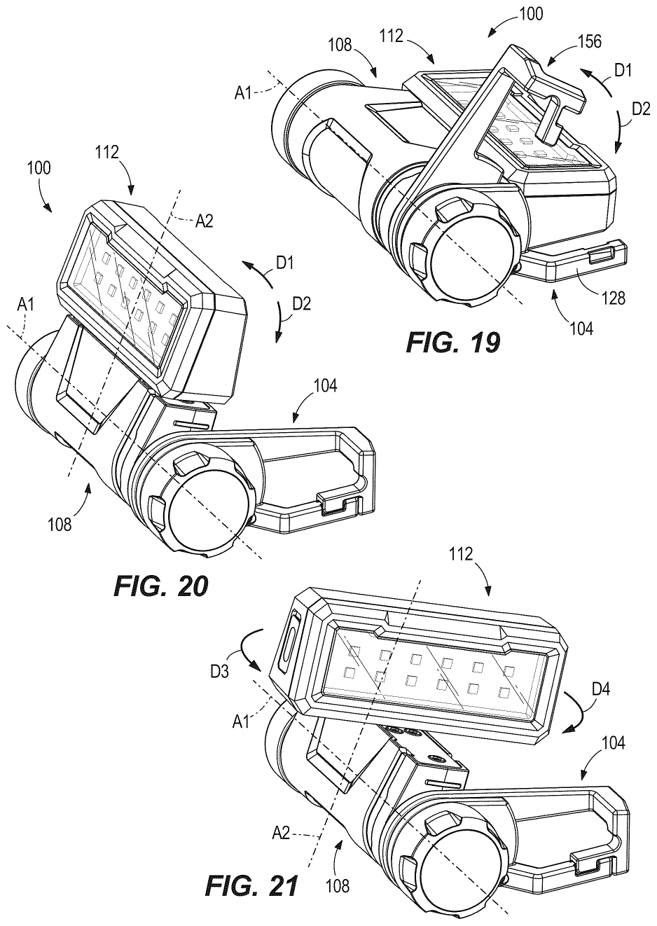

FIGS. 19-21 illustrate various movements of the portable light 100. FIG. 19 illustrates that the hook 156 is rotatable about the longitudinal axis A1 in the first direction D1 and the second direction D2. In the illustrated construction, the hook 156 can be rotated about the longitudinal axis A1 360 degrees. In other constructions, the hook 156 can be rotated about the longitudinal axis A1 less than 360 degrees. FIG. 20 illustrates the main body 108 and the light head 112 being rotatable about the longitudinal axis A1 in the first direction D1 and the second direction D2. In the illustrated construction, the main body 108 can be rotated about the longitudinal axis A1 270 degrees. In other constructions, the main body 108 can be rotated about the longitudinal axis A1 greater than or less than 270 degrees. FIG. 21 illustrates the light head 112 being rotated about a third direction D3 and a fourth direction D4 that is opposite from the third direction D3 about the light axis A2. In the illustrated construction, the light head 112 can be rotated 330 degrees about the light axis A2. In other constructions, the light head 112 can be rotated about the light axis A2 greater than or less than 330 degrees. The main body 108 and the light head 112 have dual-pivot articulation (e.g., the main body 108 moving about the longitudinal axis A1 and the light head 112 moving about the light axis A2).

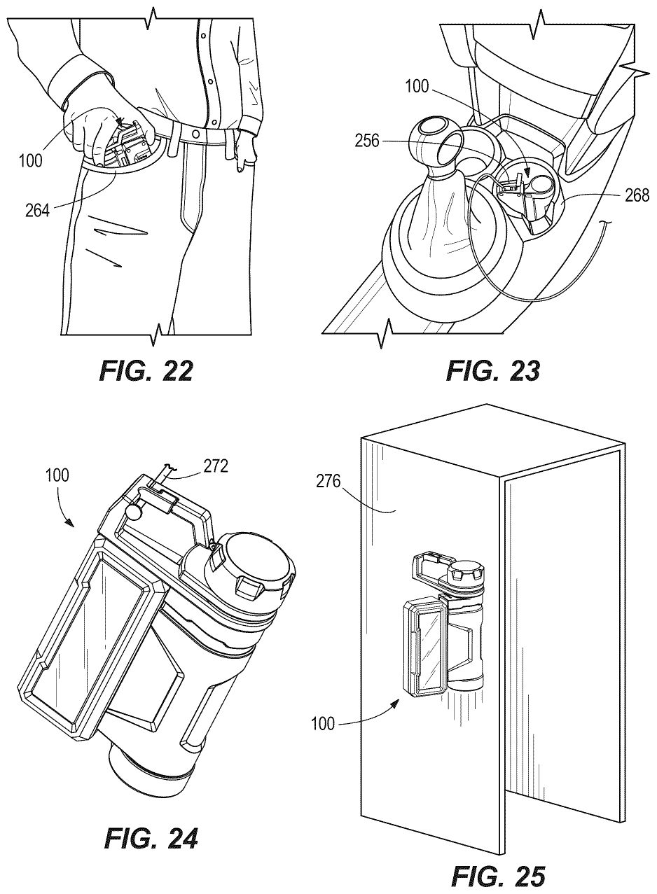

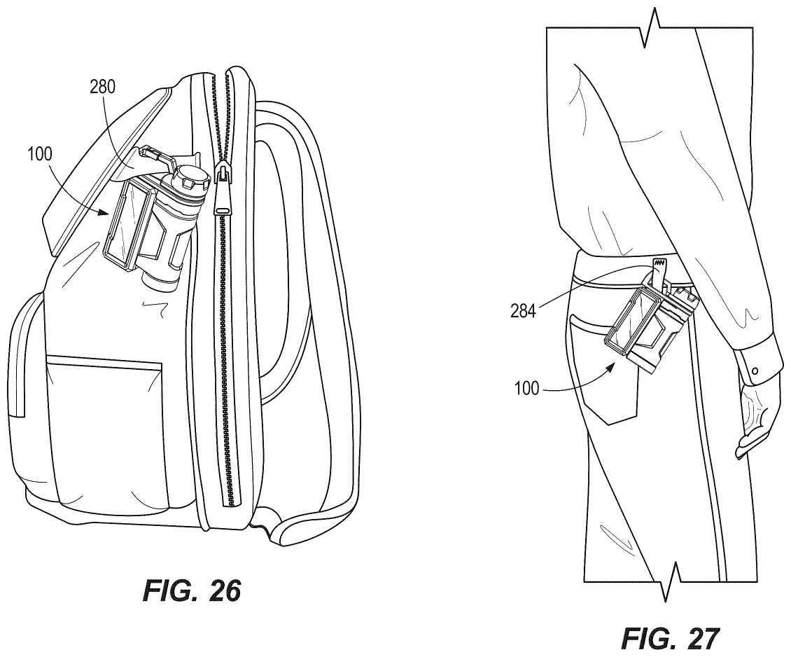

FIGS. 22-27 illustrate the portable light 100 in various locations. FIG. 22 illustrates that a profile (e.g., the lengths L1-L5) of the portable light 100 is sized to be stowed in a pocket 264 of clothing. FIG. 23 illustrates that the profile of the portable light 100 is sized to be disposed in a cup holder 268. In the illustrated construction of the portable light 100, the ports 240, 244 are disposed in the location 256 (e.g., the light head 112). FIG. 24 illustrates the locked position of the portable light such that a nail 272 is disposed in the closed loop. FIG. 25 illustrates a ferromagnetic surface 276 and the portable light 100 coupled to the ferromagnetic surface 276. In the illustrated construction, the magnet arrangement 184 of the base 104 is facing the ferromagnetic surface 276 such that the portable light 100 is supported on the ferromagnetic surface 276. FIG. 26 illustrates the portable light 100 coupled to a backpack 280. The portable light 100 is in the locked position with a portion of the backpack 280 disposed in the closed loop such that the portable light 100 is supported. FIG. 27 illustrates the portable light coupled to a belt loop 284. The portable light 100 is in the locked position with the belt loop 284 disposed in the closed loop such that the portable light 100 is supported.

FIGS. 28-30 illustrate another construction of a portable light 300. The portable light 300 includes a base 304, a main body 308 rotatably coupled to the base 304, and a light head 312 rotatably coupled to the main body 308. The base 304 includes a first end 316, a second end 320 opposite the first end 316, a longitudinal member 324 extending between the first end 316 and the second end 320, and a carabiner clip 328 extending radially outward from the first end 316. The portable light 300 includes an attachment 330 coupled to the main body 308. The attachment 330 is fixed relative to the main body 308. The portable light 300 includes the end cap 134 that is coupled to the main body 308. In the illustrated construction, the main body 308, the end cap 134, and the attachment 330 are constructed of a polymer. Specifically, the main body 308, the end cap 134, and the attachment 330 are constructed from PC+ABS JH960. The carabiner clip 328 is constructed from a metal (e.g., zinc, aluminum, steel). In the illustrated construction, the carabiner clip 328 is constructed from Zamak 5.

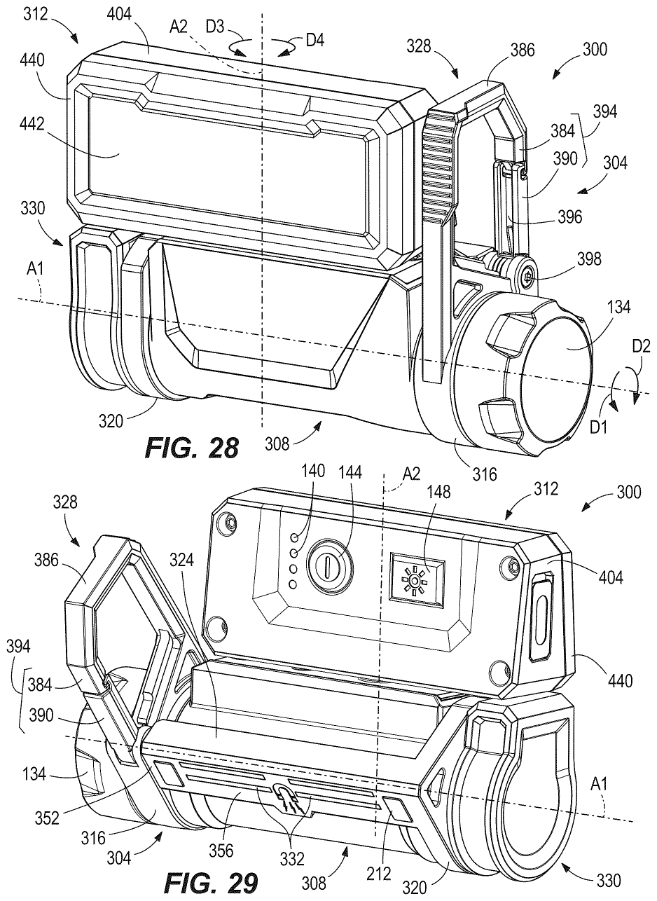

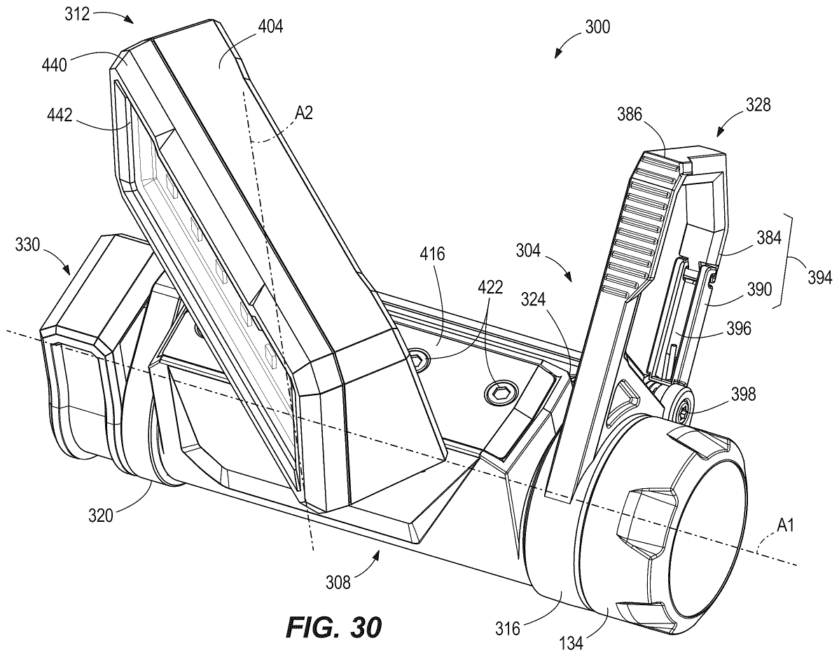

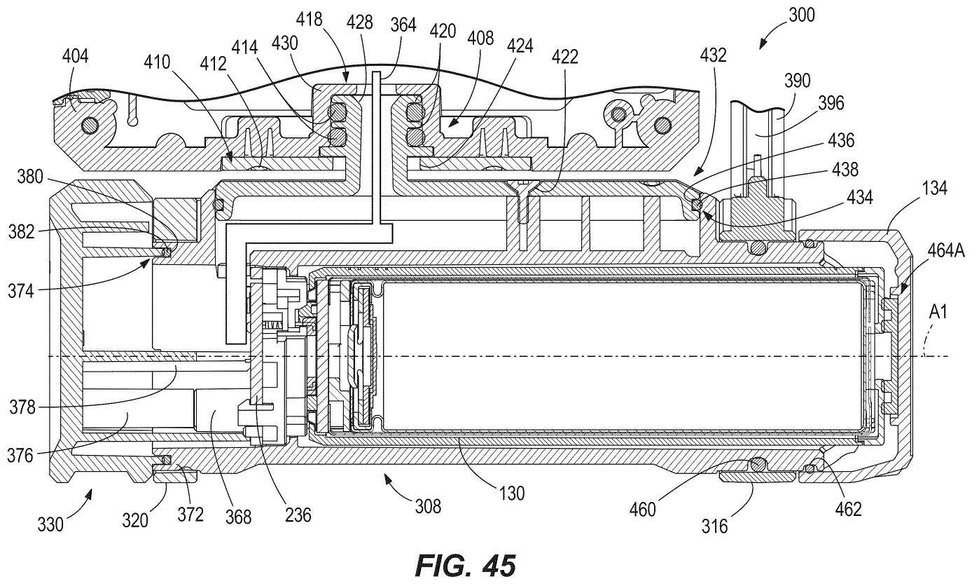

The main body 308 is received by the first end 316 and the second end 320 and extends between the first end 316 and the second end 320. In the illustrated construction, the first end 316 is a hoop shape and the second end 320 is a hoop shape. The main body 308 is rotatably coupled to the base 304 at the first end 316 and the second end 320 such that the main body 308 rotates about the longitudinal axis A1. In the illustrated construction, the first end 316 and the second end 320 are concentric with the longitudinal axis A1. The main body 308 is configured to receive the power source 130 (FIG. 45). The main body 308 is movable between the collapsed position (FIG. 28) in which the carabiner clip 328 is aligned with the light head 312 and an offset position (FIG. 29) in which the carabiner clip 328 is angularly offset relative to the light head 312 about the longitudinal axis A2. In the illustrated construction, the base 304 can be rotated 210 degrees in the second direction D2 relative to the position illustrated in FIG. 28. The light head 312 is rotatably mounted to the main body 308 and is configured to pivot about a light axis A2 (FIG. 30). In the illustrated construction, the light head 312 can be rotated 120 degrees in the third direction D3 relative to the position of the main body 308 illustrated in FIG. 28. In the illustrated construction, the light head 312 can be rotated 180 degrees in the fourth direction D4 relative to the position of the main body 308 illustrated in FIG. 28.

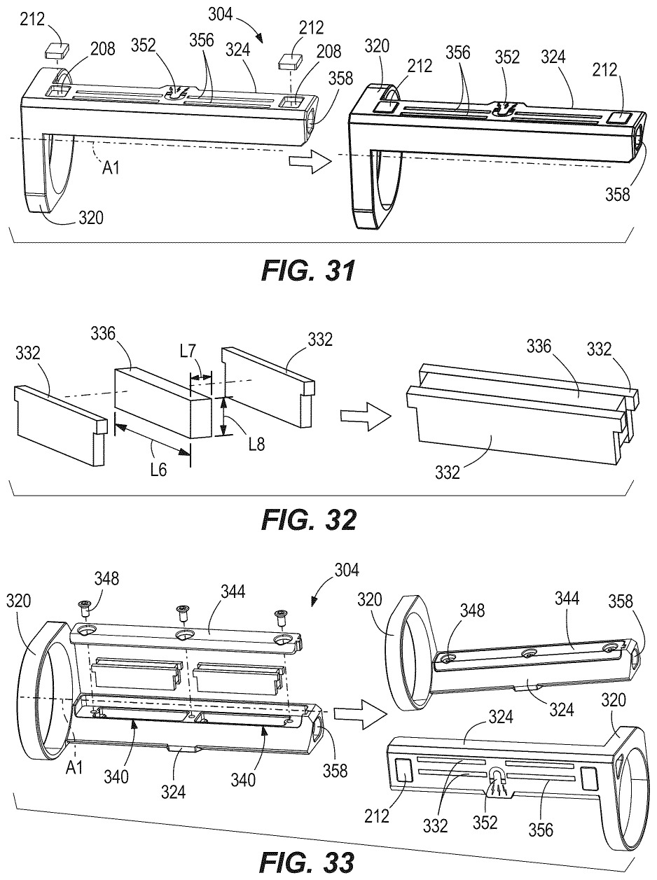

FIGS. 31-33 illustrate the assembly of the base 304. As shown in FIG. 31, the second end 320 is integrated with the longitudinal member 324 of the base 304. In other words, the second end 320 and the longitudinal member 324 are a single piece (e.g., monolithic construction). In the illustrated construction, the second end 320 and the longitudinal member 324 are constructed from a non-magnetic material (e.g., a polymer, non-magnetic metal). Specifically, the second end 320 and the longitudinal member 324 are constructed of die-cast aluminum alloy A383 (i.e., ADC12). The second end 320 includes a circular band that is configured to surround a portion of the main body 308.

As shown in FIG. 31, the base 304 includes the recesses 208 to receive the pads 212. The pads 212 are configured to form the airgap G1. In the illustrated construction, the airgap G1 provided by the pads 212 is approximately 0.2 millimeters.

FIG. 32 illustrates aligning a pair of steel plates 332 to surround a magnet 336 (i.e., the sandwich design 220 illustrated in FIG. 9). The magnet 336 defines a sixth length L6 that is measured in a direction parallel to the longitudinal axis A1. The sixth length L6 is between approximately 18 millimeters and approximately 30 millimeters. In the illustrated construction, the sixth length L6 is approximately 23 millimeters. The magnet 336 defines a seventh length L7 (e.g., a width) that is measured in a direction perpendicular to the longitudinal axis A1. The seventh length L7 is between approximately 1 millimeter and approximately 4 millimeters. In the illustrated construction, the seventh length L7 is approximately 3 millimeters. The magnet 336 defines an eighth length L8 (e.g., a height) that is measured in a direction perpendicular to the longitudinal axis A1 and the direction of the seventh length L7. The eighth length L8 is between approximately 3 millimeters and approximately 6 millimeters. In the illustrated construction, the eighth length L8 is approximately 5 millimeters. In the illustrated construction, a volume of the magnet 336 is approximately 345 mm³.

FIG. 33 illustrates placing the pair of steel plates 332 and the magnet 336 within a recess 340 of the longitudinal member 324. In the illustrated construction, the longitudinal member 324 includes two recesses 340. In other constructions, additional recesses can be added to the longitudinal member 324 to increase a number of the steel plates 332 and magnets 336 in the longitudinal member 324. The base 304 includes a cover plate 344 and fasteners 348 that extend through apertures in the cover plate 344 to couple the cover plate 344 to the longitudinal member 324. The cover plate 344 is coupled to the longitudinal member 324 and covers the recess 340 such that the magnets 336 and the steel plates 332 are disposed between the longitudinal member 324 and the cover plate 344. In the illustrated construction, the cover plate 344 is approximately the same length as the longitudinal member 324 in the direction of the longitudinal axis A1.

With continued reference to FIG. 33, after the steel plates 332 and the magnets 336 are inserted into each respective recess 340, the cover plate 344 is fastened to the longitudinal member 324 with the fasteners 348 passing through so that the steel plates 332 and magnets 336 are contained within the recesses 340. As shown in FIG. 33, the steel plates 332 and the magnets 336 are disposed between the cover plate 344 and the longitudinal member 324. The longitudinal member 324 defines a surface 352 disposed on the opposite side of the longitudinal member 324 from the cover plate 344. The longitudinal member 324 includes slots 356 on the surface 352 that are connected with the recesses 340 such that an end of the steel plates 332 extends into the slot 356. In the illustrated construction, an end of the steel plates 332 is flush with the surface 352. In other constructions, the steel plates 332 can be recessed relative to the surface 352 to increase the airgap G1. In other constructions, the steel plates 332 can protrude relative to the surface 352 to decrease the airgap G1.

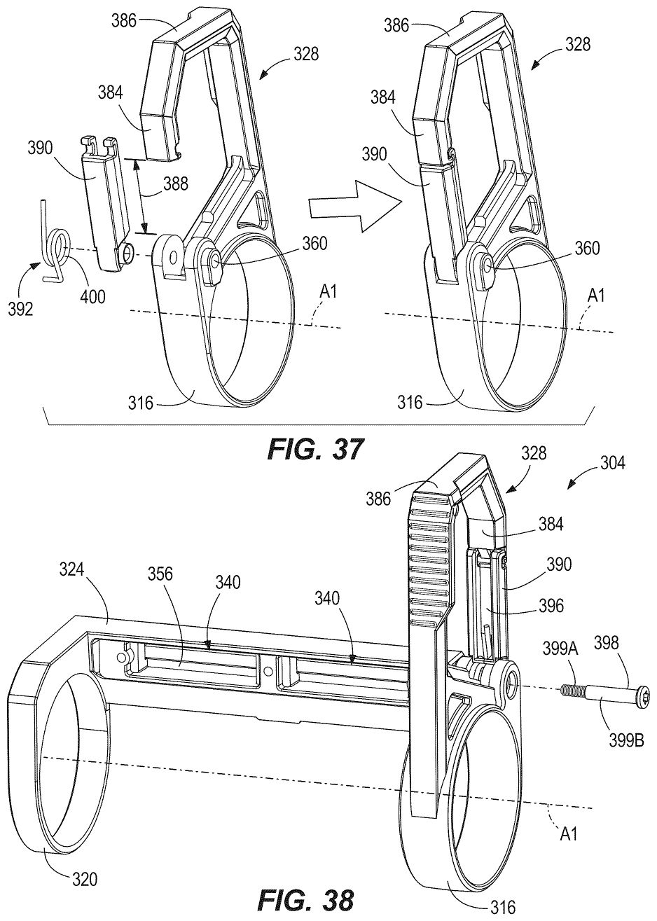

With continued reference to FIG. 33, the longitudinal member 324 includes a protrusion 358 opposite from the second end 320. In some constructions, the protrusion 358 is configured to be received by a recess (not shown) of the first end 316 of the base 304. In other constructions, the longitudinal member 324 includes a recess (not shown) that is configured to receive a protrusion 360 of the first end 316 (see FIG. 37). The protrusion 358 and recess (not shown) of the longitudinal member 324 and the protrusion 360 of the first end 316 form an interface between the longitudinal member 324 and the first end 316 such that the first end 316 is rotationally fixed relative to the longitudinal member 324.

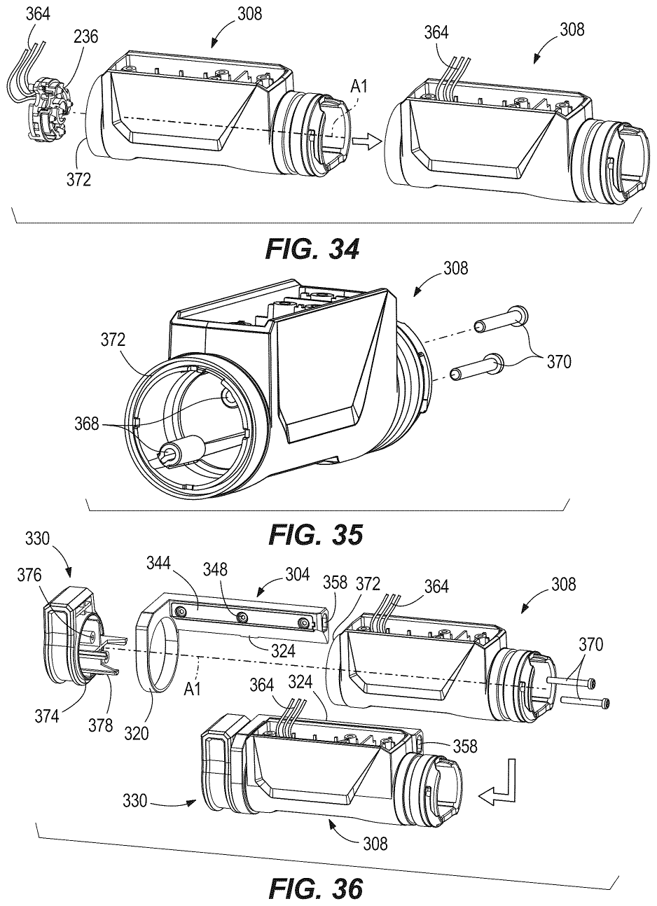

FIGS. 34-36 illustrate assembly of the main body 308. FIG. 34 illustrates the main body 308 receiving the PCB 236. The PCB 236 includes a wire harness 364 that is routed through a portion of the main body 308 that is proximal to the light head 312. The wire harness 364 is configured to provide the light head 312 with energy from the power source 130 (FIG. 45).

As shown in FIG. 35, the main body 308 includes mounting posts 368 that are disposed in an interior of the main body 308. The main body 308 includes fasteners 370 that are passed through the mounting posts 368. The main body 308 includes an end 372 having a circular cross section that receives the second end 320.

FIG. 36 illustrates mounting the attachment 330 and the second end 320 to the main body 308. The attachment 330 includes a circular protrusion 374 that protrudes from the attachment 330 in a direction parallel to the longitudinal axis A1. The attachment 330 includes mounting posts 376 that align with the mounting posts 368 of the main body 308. The mounting posts 376 are disposed radially inward relative to the circular protrusion 374. The attachment 330 includes a mounting protrusion 378 that protrudes from the attachment 330 in a direction parallel to the longitudinal axis A1.

With continued reference to FIG. 36, the circular protrusion 374 of the second end 320 is mounted over the end 372 of the main body 308. The end 372 of the main body 308 defines a diameter that is less than the inner diameter of the second end 320 such that the second end 320 slides over the end 372 along the longitudinal axis A1. In the illustrated construction, the second end 320 is concentric with the end 372 of the main body 308.

Moving briefly to FIG. 45, the connection between the attachment 330 and the main body 308 is shown. The end 372 includes a recess 380 that extends into the end 372 in a direction parallel to the longitudinal axis A1. The main body 308 includes a seal 382 disposed in the recess 380. The recess 380 receives the circular protrusion 374 of the attachment 330 such that the attachment 330 is located concentrically relative to the end 372. Also, the connection between the attachment 330 and the main body 308 is sealed via the seal 382. The mounting protrusion 378 supports the PCB 236 such that the PCB 236 is disposed between the attachment 330 and the power source 130. As shown in FIG. 45, the battery 130, the battery receptacle 131, the end cap 134, the first end 316, and the second end 320 are all aligned relative to the longitudinal axis A1.

Referring back to FIG. 36, the attachment 330 is aligned with the end 372 of the main body 308 and the fasteners 370 extend through the mounting posts 368 of the main body 308 and into the mounting posts 376 of the attachment 330 to couple the attachment 330 to the main body 308. The second end 320 of the base 304 is sandwiched between the attachment 330 and the main body 308. The attachment 330 is fixed relative to the main body 308 and therefore functions as a point of contact for a user to grasp while rotating the base 304 relative to the main body 308, or while rotating the light head 312 relative to the main body 308.

FIGS. 37 and 38 illustrate the carabiner clip 328 extending from the first end 316. The carabiner clip 328 defines a nose 384, a hook 386, and an opening 388. The carabiner clip 328 includes a gate 390 that is pivotably coupled to the carabiner clip 328 and a spring 392 that biases the gate 390 into engagement with the nose 384. In the illustrated construction, a portion of the gate 390 and the nose 384 define a kickstand 394 of the carabiner clip 328. As shown in FIG. 37, the kickstand 394 is the surface of the gate 390 and the nose 384 that engage the workpiece 216. The kickstand 394 is parallel to the surface 352 of the base 304.

As shown in FIG. 38, the gate 390 includes a recess 396 that receives a portion of the spring 392 such that the spring 392 biases the gate 390 toward closing the nose 384. The base 304 includes a fastener 398 (e.g., a shoulder bolt) to couple the first end 316 (e.g., the carabiner clip 328) to the base 304. The fastener 398 includes a threaded section 399A and an unthreaded section 399B. While the protrusion 360 of the first end 316 engages the recess (not shown) of the longitudinal member 324 such that the first end 316 is rotationally fixed relative to the longitudinal member 324, the fastener 398 axially couples the first end 316 to the longitudinal member 324 relative to the longitudinal axis A1. In particular, the threaded section 399A of the fastener 398 threadably couples to the longitudinal member 324. Also, the fastener 398 couples the gate 390 to the carabiner clip 328 such that the gate 390 is pivotable relative to the carabiner clip 328. In particular, the carabiner clip 328 is rotatable about the unthreaded section 399B of the fastener 398. Also, the fastener 398 passes through an opening 400 of the spring 392. In other words, the fastener 398 functions as a spring centering diameter. The single shoulder bolt 398 used for coupling the gate 390 to the carabiner clip 328 and the carabiner clip 328 and the gate 390 to the longitudinal member reduces the number of parts for assembly and results in a simplified construction of the base 304.

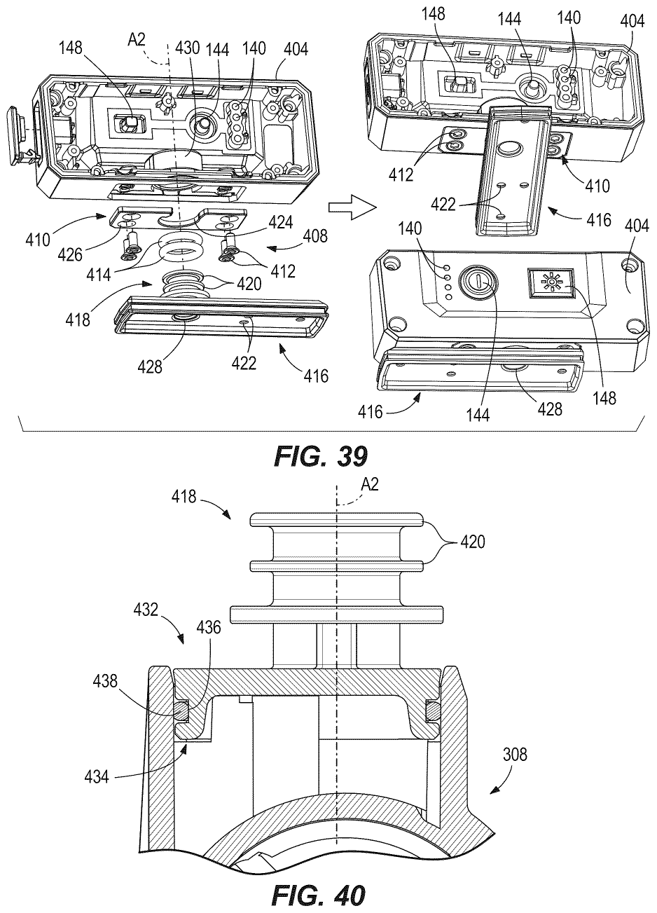

FIG. 39 illustrates the light head 312 of the portable light 300. The light head 312 includes a housing 404 and a hinge 408 configured to permit the light head 312 to pivot about the light axis A2. The hinge 408 includes a first plate 410, a plurality of fasteners 412, a plurality of seals 414, and a second plate 416. The first plate 410 is constructed from a metal (e.g., zinc, aluminum, steel). In the illustrated construction, the first plate 410 is constructed from steel. The second plate 416 includes a protrusion 418 with ridges 420 and a plurality of apertures 422. In the illustrated construction, the second plate 416 is comprised of a metal (e.g., zinc, aluminum, steel). In the illustrated construction, the second plate 416 is constructed from Zamak 5.

The first plate 410 includes a central aperture 424 sized to permit the accommodation of the ridges 420 and a plurality of apertures 426 configured to receive the plurality of fasteners 412. The housing 404 includes a receptacle 430 configured to receive the protrusion 418 and the ridges 420. To assemble the hinge 408, the first plate 410 is fastened to the housing 404 with the plurality of fasteners 412 extending through the plurality of apertures 426 and into the housing 404. Seals of the plurality of seals 414 are disposed between adjacent ridges 420 and the protrusion 418 is inserted through the central aperture 424 such that the protrusion 418 is received by the receptacle 430 of the housing 404. The plurality of seals 414 are configured to inhibit the ingress of water through the hinge 408. The protrusion 418 includes a central aperture 428 that permits the wire harness 364 to pass through.

FIG. 40 illustrates another construction of a second plate 432 that is interchangeable with the second plate 416. The second plate 432 includes a protrusion 434 that extends from the second plate 432 in an opposite direction from the protrusion 418. The protrusion 434 includes a groove 436 that is configured to receive a seal 438 such that an interface between the second plate 432 and the main body 308 is sealed. Briefly moving to FIG. 45, the second plate 432 is illustrated with the hinge 408 and the plurality of seals 414 are configured to create a seal between the protrusion 418 and the receptacle 430 of the housing 404.

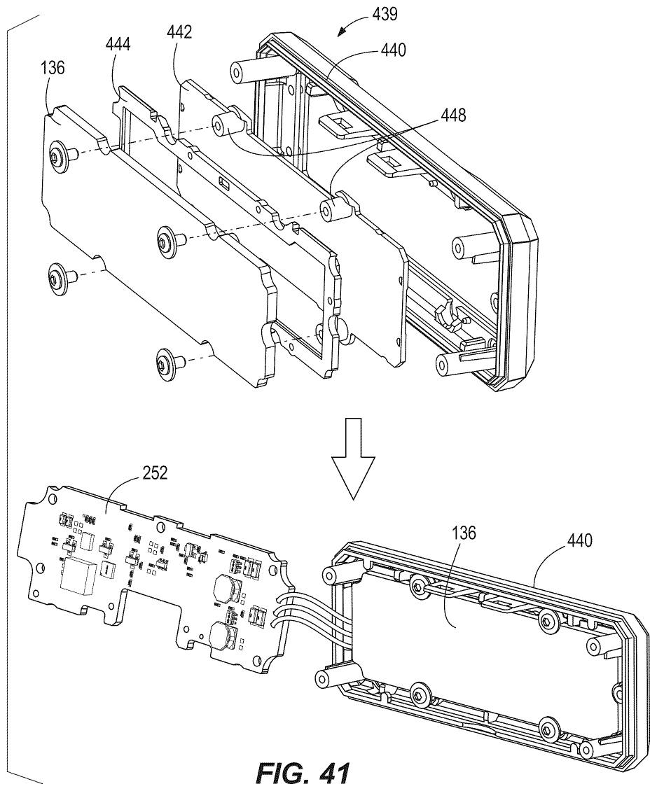

FIG. 41 illustrates a lens assembly 439 of the portable light 300. The lens assembly 439 includes a frame 440, a lens cover 442, a spacer 444, and the light source 136. In the illustrated construction, the frame 440 is constructed from a polymer. In the illustrated construction, the frame 440 is constructed from TPE 350BK001. In the illustrated construction, the lens cover 442 is constructed from a polymer. In the illustrated construction, the lens cover 442 is constructed from PC 1000R.

To assemble the lens assembly 439, the lens cover 442 is inserted into the frame 440, the spacer 444 is inserted into the frame 440 such that the spacer 444 is disposed between the lens cover 442 and the light source 136. The light source 136 is fastened to posts 448 of the lens cover 442. The PCB 252 is coupled to the light source 136.

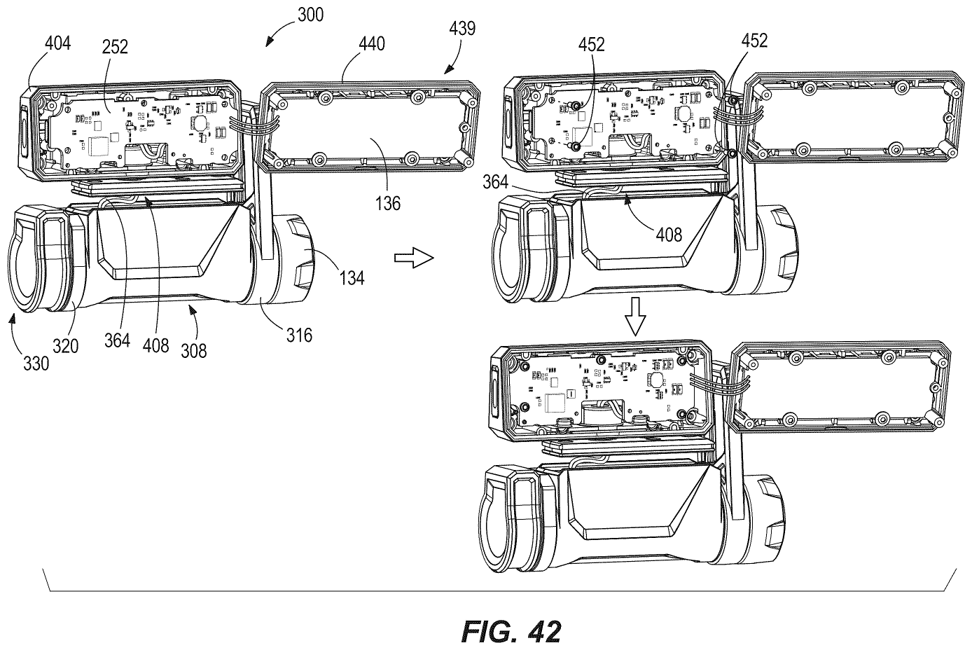

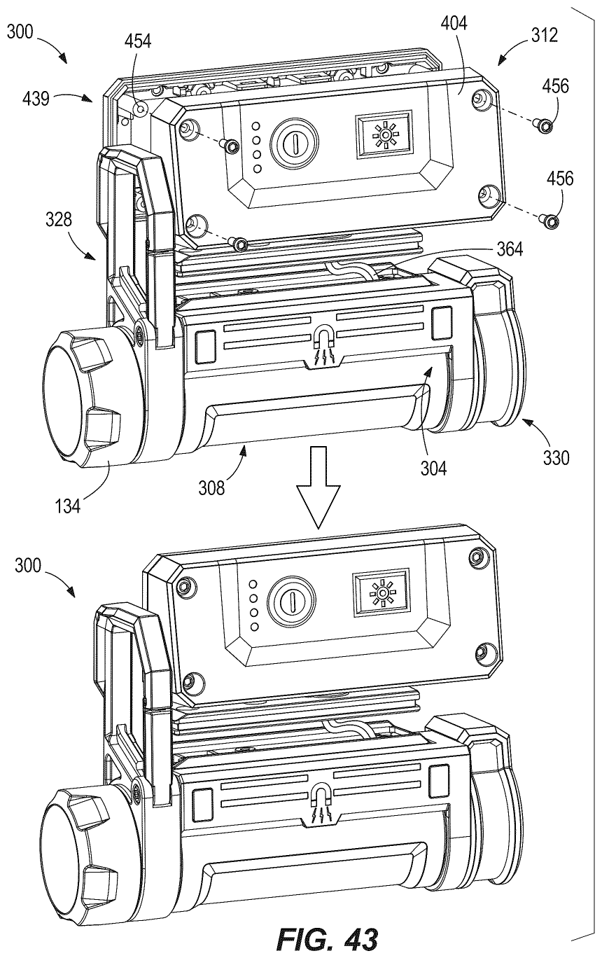

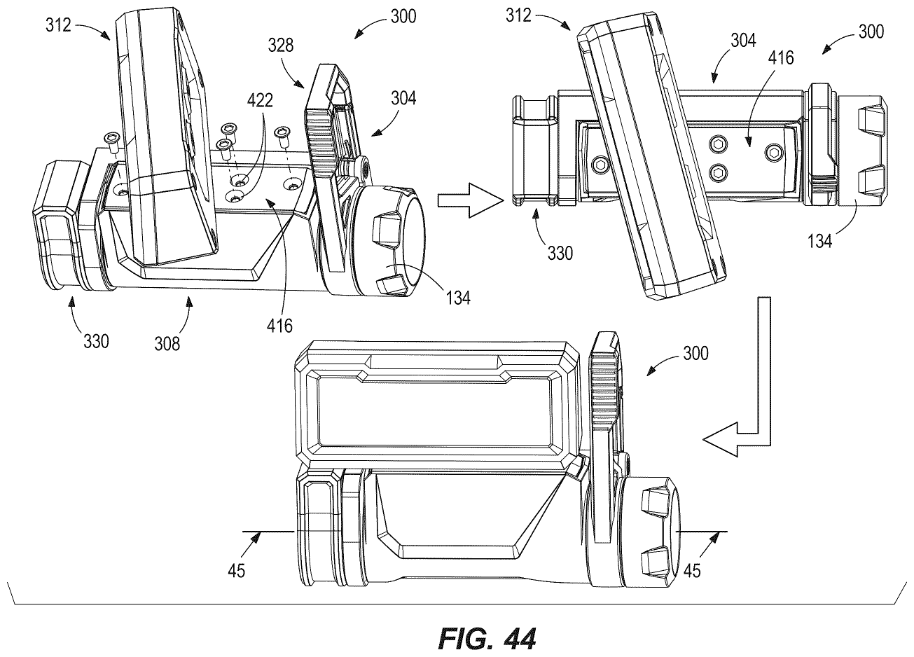

As shown in FIG. 42, the wire harness 364 is passed through the hinge 408 and is connected to the PCB 252. The PCB 252 is then coupled to the housing 404 of the light head 312 via fasteners 452. FIG. 43 illustrates coupling the lens assembly 439 to the housing 404. The frame 440 includes posts 454 that are configured to receive fasteners 456. To couple the frame 440 to the housing 404, the fasteners 456 are passed through the housing 404 and into the posts 454. FIG. 44 illustrates coupling the light head 312 and the main body 308 together. To couple the light head 312 to the main body 308, fasteners are passed through the plurality of apertures 422 of the second plate 416 and into the main body 308.

FIG. 45 illustrates a cross section taken through the longitudinal axis A1 of the portable light 300 fully assembled. The portable light 300 includes the end cap 134 that is coupled to the main body 308 proximal to the first end 316 of the base 304. Specifically, the end cap 134 is threadably coupled to the main body 308 such that the first end 316 is sandwiched between the end cap 134 and the main body 308. The first end 316 includes a seal 460 disposed between the first end 316 and the main body 308, and the end cap 134 includes a seal 462 disposed between the end cap 134 and the main body 308. The seal 460 is configured to provide resistance between the main body 308 and the carabiner clip 328. The resistance between the main body 308 and the carabiner clip 328 is provided such that the position of the main body 308 relative to the base 304 (e.g., the carabiner clip 328) does not change unless a user rotates either component relative to the longitudinal axis. In the illustrated construction, the resistance (i.e., rotational torque) for moving the main body 308 relative to the base 304 is between 1.7 in-lb and 7.5 in-lb. The rotational torque was measured by holding the carabiner clip 328 and biasing an edge of the light head 312 along the axis A2 most distal from the main body 308. The seal 462 is configured to inhibit the ingress of water between the main body 308 and the end cap 134. FIG. 45 illustrates that the end cap 134 includes a power contact 464A that establishes a connection with the power source 130 such that power is provided to the PCB 252.

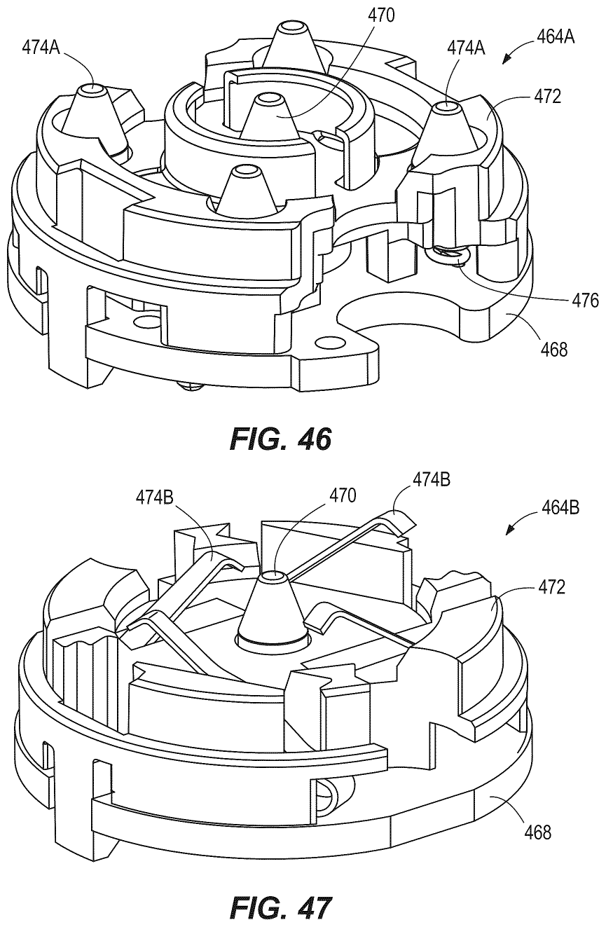

FIG. 46 illustrates the power contact 464A. The power contact 464A includes an elastomeric bumper 468 (e.g., rubber, neoprene, etc.). The elastomeric bumper 468 is configured to deform as the end cap 134 is coupled to the main body 308. The power contact 464A includes a central terminal 470 that is in contact with a central portion of an end of the power source 130. A spring (not shown) is disposed between the central terminal 470 and the elastomeric bumper 468 such that the central terminal 470 is biased toward a retaining cover 472. The power contact 464A includes peripheral terminals 474A that are biased by springs 476 toward the retaining cover 472. FIG. 47 illustrates another construction of a power contact 464B that is interchangeable with the power contact 464A. In contrast to the power contact 464A, the power contact 464B includes peripheral terminals 474B that are leaf springs. Additional details regarding the power contacts 464A, 464B and the battery 130 and/or functions thereof are disclosed in U.S. patent application Ser. No. 19/382,461, the entire contents of which are incorporated herein by reference.

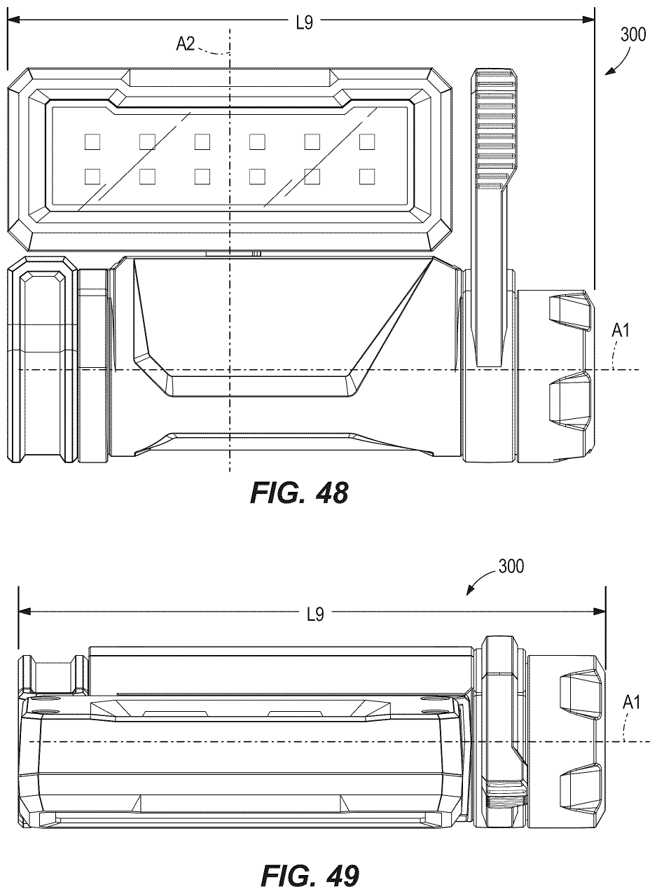

FIGS. 48 and 49 illustrate the portable light 300 defining a ninth length L9. The ninth length L9 is defined by the end cap 134, the main body 308, and the attachment 330. The ninth length L9 is measured in a direction parallel to the longitudinal axis A1. The ninth length L9 is between approximately 100 millimeters and approximately 130 millimeters. In the illustrated construction, the ninth length L9 is approximately 119 millimeters.

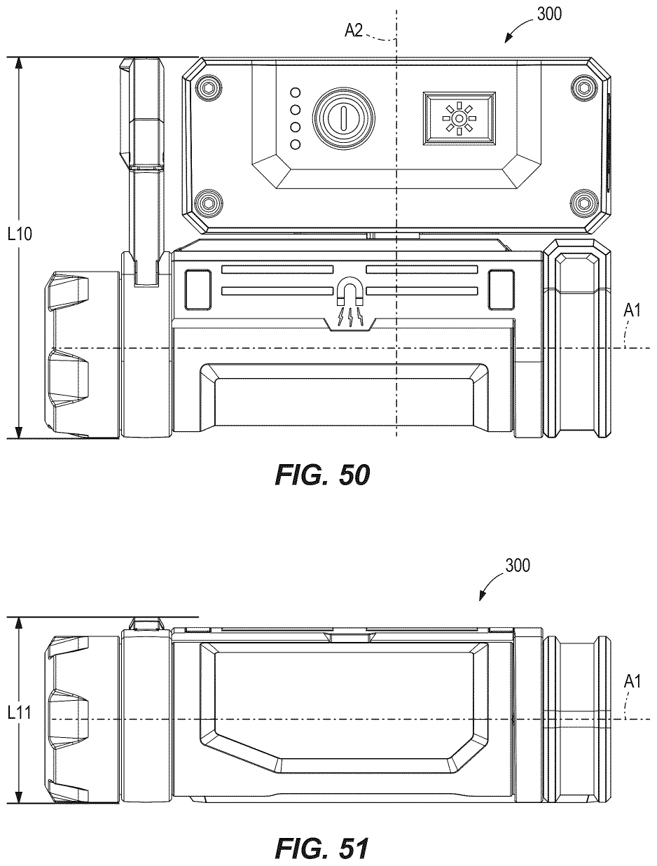

FIG. 50 illustrates the portable light 300 defining a tenth length L10. The tenth length L10 is defined by the first end 316 (e.g., the carabiner clip 328). The tenth length L10 is measured in a direction parallel to the light axis A2. The tenth length L10 is between approximately 30 millimeters and approximately 90 millimeters. In the illustrated construction, the tenth length L10 is approximately 80 millimeters.

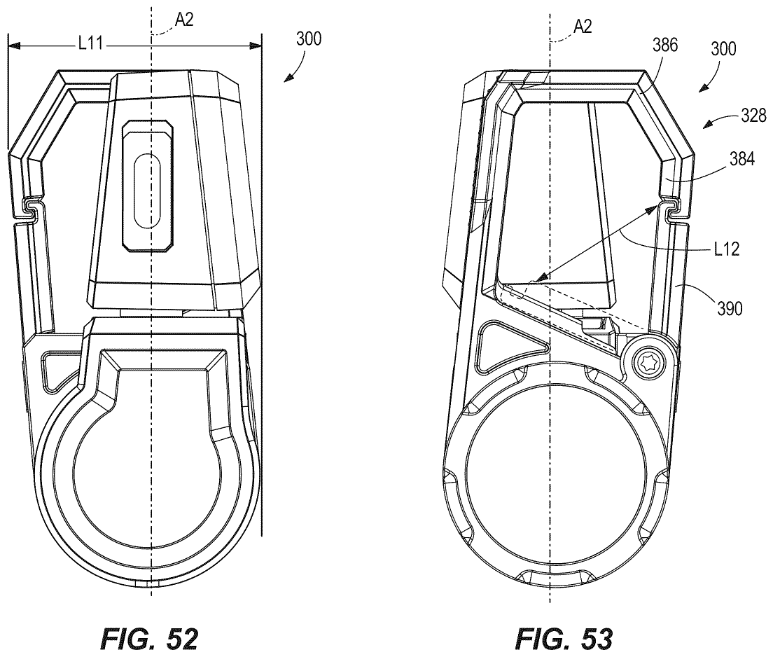

FIGS. 51-53 illustrate the portable light 300 defining an eleventh length L11. The eleventh length L11 is defined by the first end 316 (e.g., the carabiner clip 328). The eleventh length L11 is between approximately 20 millimeters and approximately 40 millimeters. In the illustrated construction, the eleventh length L11 is approximately 34 millimeters. The portable light 300 weighs between approximately 5 ounces and approximately 10 ounces. In the illustrated construction, the weight is approximately 7 ounces.

FIG. 53 illustrates a twelfth length L12 defined between a difference in position of the gate 390 between a closed and an open position of the gate 390. In the closed position of the gate 390, the gate 390 contacts the nose 384. In the open position, the gate 390 contacts the carabiner clip 328. In the illustrated construction, the twelfth length L12 is approximately 16.8 millimeters.

Although the disclosure has been described in detail with reference to certain preferred constructions, variations and modifications exist within the scope and spirit of one or more independent aspects of the disclosure as described.

What is claimed is:

1. A portable light comprising:
a base including a first end, a second end opposite the first end, a longitudinal member extending between the first end and the second end, and a kickstand extending radially outward from the first end;
a main body defining a central longitudinal axis, the main body being rotatably coupled to the base at the first end and the second end such that the main body is rotatable relative to the base about the central longitudinal axis, the main body configured to support a power source; and
a light head rotatably coupled to the main body, the light head including a light source configured to be selectively powered by a power source.

2. The portable light of claim 1, further comprising a magnet disposed in the longitudinal member.

3. The portable light of claim 2, further comprising a pair of steel plates configured to surround the magnet, wherein the longitudinal member includes a recess configured to receive the magnet and the pair of steel plates.

4. The portable light of claim 3, wherein the magnet is a first magnet, the pair of steel plates are a first pair of steel plates, and the recess is a first recess, and further comprising:
a second magnet;
a second pair of steel plates configured to surround the second magnet; and
a second recess spaced apart from the first recess along a direction parallel to the central longitudinal axis, the second recess configured to receive the second magnet and the second pair of steel plates.

5. The portable light of claim 3, further comprising a cover plate coupled to the longitudinal member and configured to cover the recess, wherein the magnet and the pair of steel plates are disposed between the longitudinal member and the cover plate.

6. The portable light of claim 1, wherein the base includes a carabiner clip and wherein the kickstand is partially defined by the carabiner clip.

7. The portable light of claim 6, wherein the carabiner clip includes a gate pivotably coupled to the carabiner clip.

8. The portable light of claim 7, wherein the base includes a fastener configured to couple the carabiner clip to the base.

9. The portable light of claim 8, wherein the fastener couples the gate to the carabiner clip.

10. The portable light of claim 1, further comprising an end cap coupled to an end of the main body such that the first end of the base is sandwiched between the end cap and the main body, wherein the end cap is configured to selectively enclose the power source in the main body.

11. A portable light comprising:
a base including a first end, a second end opposite the first end, a longitudinal member extending between the first end and the second end, and a carabiner clip extending radially outward from the first end;
a main body defining a central longitudinal axis, the main body being rotatably coupled to the base at the first end and the second end such that the main body is rotatable relative to the base about the central longitudinal axis, the main body configured to support a power source; and
a light head rotatably coupled to the main body by a hinge such that the light head is rotatable relative to the main body about a light axis that is perpendicular to the central longitudinal axis, the light head including a light source configured to be selectively powered by a power source.

12. The portable light of claim 11, further comprising an attachment coupled to an end of the main body such that the second end of the base is sandwiched between the attachment and the main body, wherein the attachment is rotationally and axially fixed along the central longitudinal axis relative to the main body.

13. The portable light of claim 12, further comprising an end cap coupled to another end of the main body such that the first end of the base is sandwiched between the end cap and the main body, the another end being opposite from the end of the main body.

14. The portable light of claim 11, wherein the carabiner clip includes a gate pivotably coupled to the carabiner clip and a spring configured to bias the gate.

15. The portable light of claim 14, wherein the base includes a fastener configured to couple the carabiner clip to the base.

16. The portable light of claim 15, wherein the fastener couples the gate to the carabiner clip and is configured as a spring centering diameter.

17. The portable light of claim 11, wherein the light head includes a housing having a receptacle and wherein the hinge includes
the receptacle of the housing of the light head,
a first plate,
a second plate having a protrusion with ridges,
a plurality of seals, each of the plurality of seals disposed in a ridge of the ridges, and
a plurality of fasteners,
wherein the plurality of fasteners couple the first plate to the housing of the light head such that a ridge of the protrusion is disposed between the first plate and the housing of the light head.

18. A portable light comprising:
a base including a first end, a second end opposite the first end, a longitudinal member extending between the first end and the second end, the first and the second end each have a hoop shape;
a main body defining a central longitudinal axis, the main body being rotatably coupled to the base at the first end and the second end such that the main body is rotatable relative to the base about the central longitudinal axis, the main body including a battery receptacle configured to support a power source; and
a light head rotatably coupled to the main body, the light head including a light source configured to be selectively powered by a power source.

19. The portable light of claim 18, further comprising an end cap coupled to an end of the main body such that the first end of the base is sandwiched between the end cap and the main body, wherein the first and the second end of the base, the battery receptacle, the power source, and the end cap are aligned with the central longitudinal axis.

20. The portable light of claim 18, wherein the light head is rotatably coupled to the main body by a hinge such that the light head is rotatable relative to the main body about a light axis that is perpendicular to the central longitudinal axis.
